(19) United States
(12) Patent Application Publication
(10) Pub. No.: US 2024/0330163 A1
(43) Pub. Date: Oct. 3, 2024

(54) COMPILER CACHING

(71) Applicant: Modular, Inc., Redwood City, CA (US)

(72) Inventors: Aman LaChapelle, Mountain View, CA (US); Chris Lattner, Los Altos Hills, CA (US)

(21) Appl. No.: 18/617,409

(22) Filed: Mar. 26, 2024

Related U.S. Application Data
(60) Provisional application No. 63/454,892, filed on Mar. 27, 2023.

(51) Int. Cl. G06F 11/36

(52) U.S. Cl. CPC G06F 11/3684; G06F 11/3688

(57) ABSTRACT

A system for caching compiler transformations. The compilation system uses a parametrized hash in a form of a parametrized Content Addressable Store IDentifier (parametrized CAS ID) to store operator regions and arbitrary transformations over arbitrary operations of the compiler intermediate representation (IR). The parametrized CAS ID includes a hash of a content of a region of an operation, and a set of parameters including a set of symbolic references to objects used and/or referenced within the region of the operator.

### CLAIM OF PRIORITY

This application claims the benefit of priority under 35 U.S.C. § 119 (e) to U.S. Patent Application Ser. No. 63/454,892, filed on Mar. 27, 2023, which is incorporated by reference herein in its entirety.

### TECHNICAL FIELD

The present disclosure relates generally to compilers, and more specifically to compilers for computationally intensive code.

### BACKGROUND

Compliers are used to generate object code from high-level languages. It is desirable to generate optimized object code.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a data flow diagram of a kernel generation and use process, in accordance with some examples.

FIG. 2 is a collaboration diagram of a compilation system, in accordance with some examples.

FIG. 3 is an activity diagram of a kernel generation method, in accordance with some examples.

FIG. 4 is an activity diagram of a generator elaboration method, in accordance with some examples.

FIG. 5A FIG. 5A is an activity diagram of a caching method, in accordance with some examples.

FIG. 5B illustrates an intermediate representation of a program, in accordance with some examples.

FIG. 5C illustrates a modified intermediate representation having parameterized CAS IDs replacing cached regions of an intermediate representation, in accordance with some examples.

FIG. 5D illustrates a structure of a cache, in accordance with some examples.

FIG. 6A illustrates a cached intermediate representation, in accordance with some examples.

FIG. 6B illustrates portions of an intermediate representation at a time step 0, in accordance with some examples.

FIG. 6C illustrates portions of an intermediate representation at a time step 1, in accordance with some examples.

FIG. 6D illustrates portions of an intermediate representation at a time step 2, in accordance with some examples.

FIG. 6E illustrates of an output intermediate representation, in accordance with some examples.

FIG. 7 illustrates an elaboration of a generator, in accordance with some examples.

FIG. 8 is a deployment diagram of a networked compilation environment, in accordance with some examples.

FIG. 9 is an architecture diagram of a machine within which a set of instructions may be executed for causing the machine to perform any one or more of the methodologies discussed herein, in accordance with some examples.

### DETAILED DESCRIPTION

Compilers rely on tools like cache to provide compile-time memoization operations where intermediate compilation results for source files are stored in a cache for later reuse. For distributed compilation and builds, various tools are available such as Bazel that rely on file-level hashes of file content to determine which portions of source code should be recompiled because of a change in the file. By using a source file as the lowest level of granularity results in inefficient compilation as even trivial changes in a source file, such as reformatting for readability or a change in a remark may trigger recompilation of a source file.

Compilers use an amount of memory proportional to the number of operations in an Intermediate Representation (IR) of a program. For substantial programs, this can mean many thousands of lines of code which translates into more than double that many lines of textual IRs. The compiler's job is to then repeatedly walk the IR through a number of passes and perform transformations. For a language like C or C++, this is done for an entire translation unit (file) at a time. This means that making a change in a single line of code, even if just to make a comment, in a large file with many private functions, the whole file is recompiled because a compiler doesn't have a context required to know what actually changed and what actually needs to be recompiled.

By making the basic atom of computing a symbol operation (e.g., a function) a compiler no longer has to recompile every function in the file if one of the functions changes. This dramatically increases a cache hit rate in a cache of memoized intermediate compilation results. Furthermore, the IRs for the other functions in the file are not needed. By using a call graph, a compiler can statically determine which functions should be recompiled and avoid recompiling the whole file.

Examples of the present disclosure provide for caching a region attached to an IR of an operation rather than at the level of a source function. In some examples, multiple levels within the IR of the function are cached. In some examples, transformations are cached. Conceptually, caching a transformation creates a Merkle tree from the code plus transformations on the code.

In some examples, a parameterized hash in a form of a parametrized Content Addressable Store IDentifier (parameterized CAS ID) is provided. A parameterized CAS ID provides a structure where some portions of a code object or “blob” to be hashed are not part of the content of the hash of the code object. This enables performing a set of operations on cached data without retrieving the cached data from the cache at all. Example operations include, but are not limited to, a weight update for a static neural network architecture, recompilation and relinking of a single function out of a large program, and the like.

In some examples, use of a parameterized CAS ID trims a depth of a Merkle tree required to uniquely identify a cached function (which leads to more cache hits) and brings attributes up to the top level of a program being compiled where the attributes can be easily instrumented.

In some examples, changing a compilation paradigm from ‘producing files’ to ‘producing parameterized CAS IDs’ means that distributed compilation becomes simple to implement by having a distributed hash table to store compilation artifacts using parameterized CAS IDs as keys into the hash table.

Although described in terms of compilation of kernels for performing many types of computations, it is to be understood that the caching and compilation methodologies described herein can be applied to the processing of any type of computer program or code, or the memoization of intermediate results for many types of multistep or distributed computations.

Other technical features may be readily apparent to one skilled in the art from the following figures, descriptions, and claims.

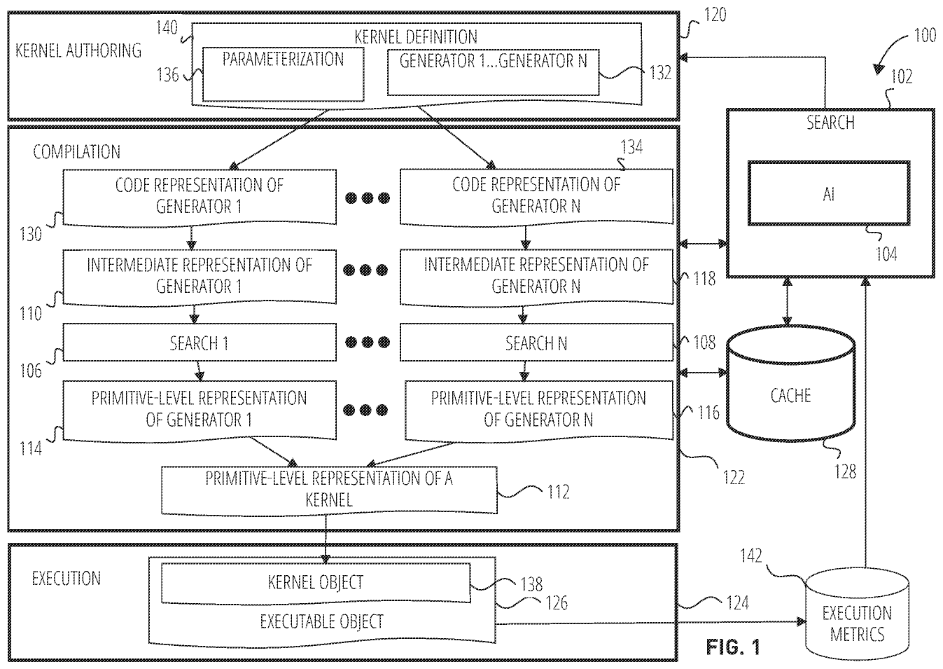

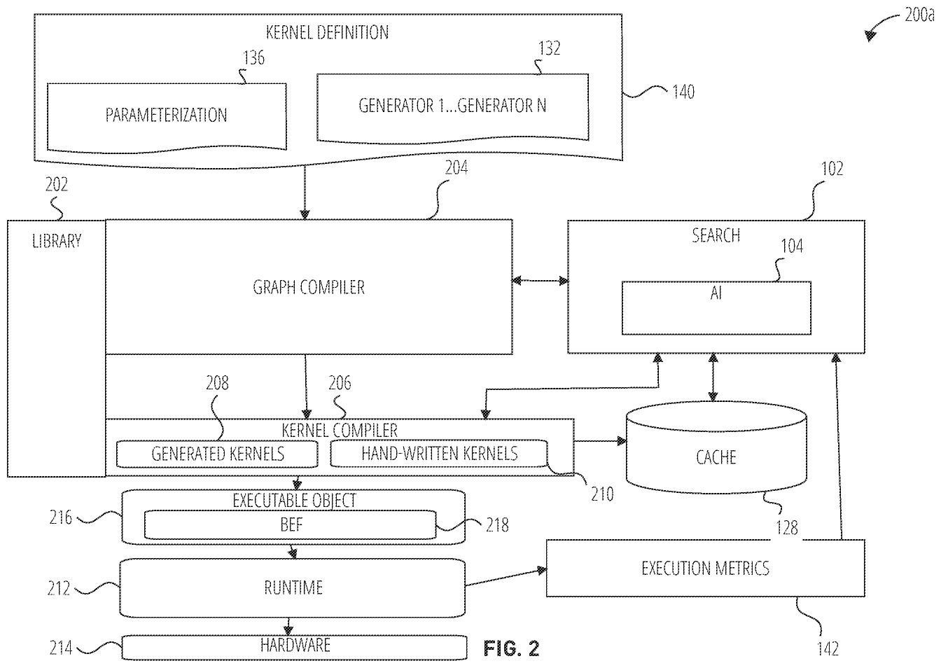

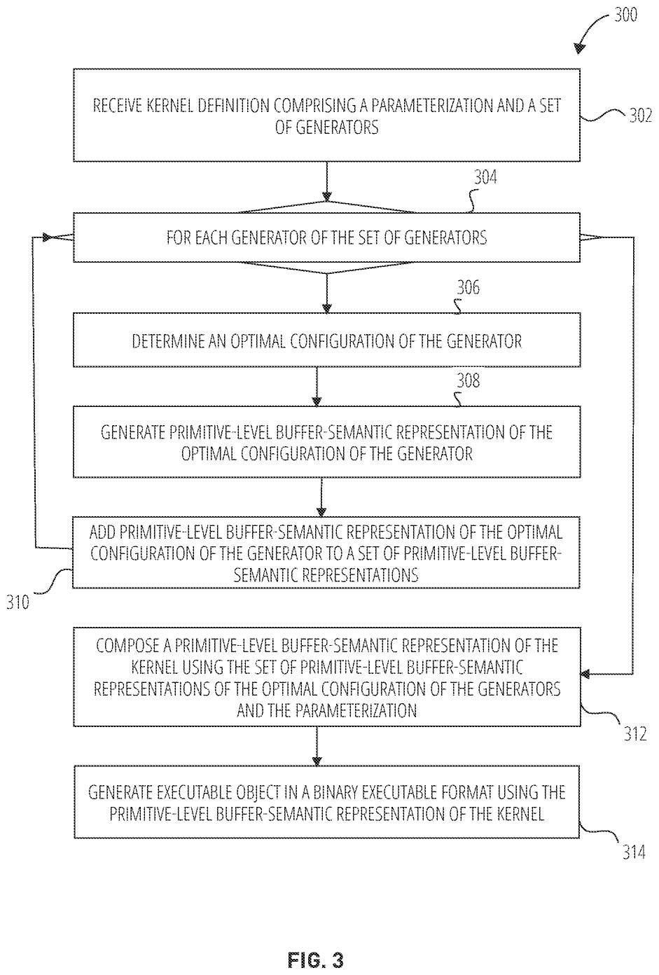

FIG. 1 is a data flow diagram of a compilation and execution process 100, in accordance with some examples. A user authors a kernel definition 140 during an authoring phase 120. The kernel definition 140 is used to compose a primitive-level representation of a kernel 112 in a compilation phase 122 as more fully described in reference to FIG. 3, by a compilation system 200a as more fully described in reference to FIG. 2.

The kernel definition 140 is comprised of a parameterization 136 and one or more generators 132. The generators 132 comprise coding logic, as illustrated by code representation of generator 1 130 and code representation of generator N 134, defining one or more operations to be performed by a kernel in accordance with the kernel definition 140. The operations may be organized into coding logic components such as, but not limited to operations, operators, functions, objects, routines, subroutines, modules, and the like, that operate on one or more data buffers. In some examples, the one or more generators 132 comprise definitions of one or more data structures comprising the data buffers.

The parameterization 136 comprises a set of parameters that guide how a compiler, such as graph compiler 204 or kernel compiler 206 (of FIG. 2), compiling the kernel definition 140 generates a primitive-level representation of a kernel 112 using the generators 132. In some examples, a generator 132 is written in a general purpose programming language such as Python or the like. In some examples, the parameterization 136 is a set of kernel parameters. In some examples, the parameterization 136 is comprised of a parsable scripting language or the like that generates the kernel parameters.

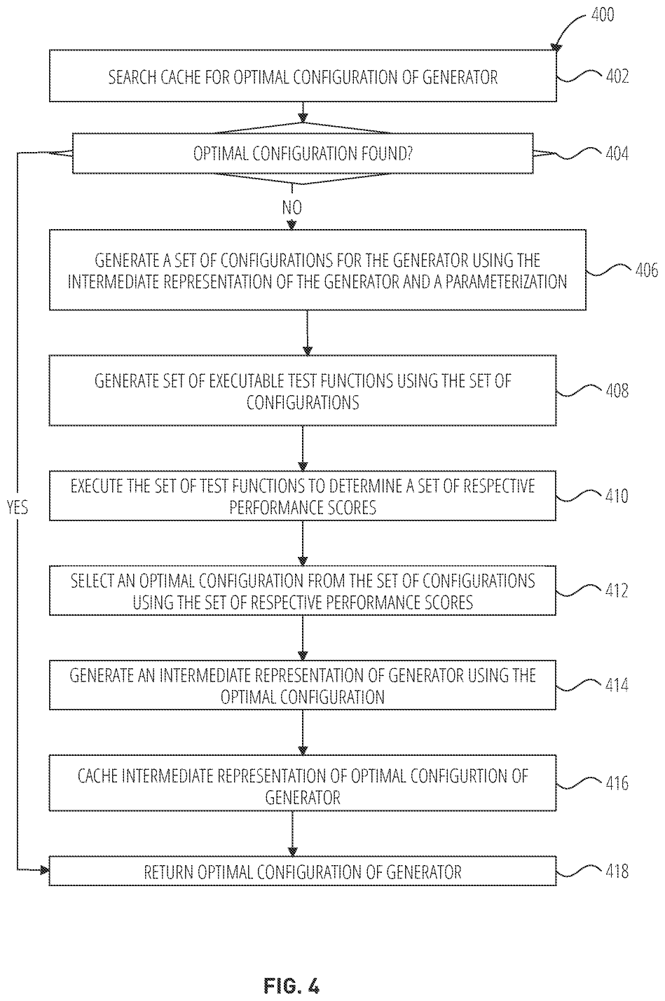

During the compilation phase 122, code of a generator 132, such as code representation of generator 1 130 and code representation of generator N 134, is lowered from the general purpose programming language into a lower level representation of the generator, such as primitive-level representation of generator 1 114 and primitive-level representation of generator N 116, through a series of intermediate representations, as illustrated by intermediate representation of generator 1 110 and intermediate representation of generator N 118. During the compilation phase 122, optimal configurations of the generators 132 are determined in a search, such as search 1 106 and search N 108, using the parameterization 136 and the intermediate representations of the generators 132 in a process more fully described in reference to FIG. 4. Search results and other compilation metrics are stored in a cache 128 for use during a subsequent search. A search may comprise searching through a tree of possible configurations using a combination of static analysis of prior configurations and a dynamic analysis of proposed configurations performed during an elaboration process as more fully described in reference to FIG. 4.

The primitive-level buffer-semantic representations of the generators 132 are combined into a primitive-level representation of a kernel 112. The primitive-level representation of a kernel 112 is stored for later use.

To generate an executable object, a kernel object 138 is generated using the primitive-level representation of a kernel 112 and the kernel object 138 is included in an executable object 126. Once generated, the executable object 126 is executed during the execution phase 124 and uses the kernel object 138 to perform one or more computations. In some examples, a library 202 is used to augment the kernel object 138 with additional executable objects.

In some examples, execution metrics of the kernels are stored in a datastore of execution metrics 142. The execution metrics 142 are used by a subsequent search component 102 to determine an optimal configuration of the one or more generators 132.

In some examples, an Artificial Intelligence (AI) component 104 is used to assist in a search. In some examples, the AI component 104 also assists during an authoring phase 120 during which kernels are written within a Software Development Environment (SDE) of an Integrated Development Environment (IDE).

In some examples, one or more operations are defined by the generators 132 as a fusion of several other lower level operations, e.g., broadcast, activation operations, and sometimes even larger fused amalgams like Long Short-Term Memory (LSTM) operations. Describing generators at this level of abstraction simplifies high-level optimizations such as, but not limited to, extraction of shape operators, generation of operator gradients, and the like.

In some examples, the one or more generators 132 are used to generate implementations of existing functions or operators in existing Machine Learning (ML) frameworks (TFLite, TF, ONNX, PyTorch, and the like.). Operators in existing ML frameworks have attributes such as, but not limited to, broadcasting and type promotion support, handwritten operators chosen by experts that are known to be important to certain classes of models, e.g., activation operators fused into element wise generators like “add”, support for quantized algorithms that depend on architecture-specific DSP operations, layouts assumed by existing frameworks, support for dynamic shapes and dynamic dtypes, and the like.

In some examples, generators support:
Dynamic shapes
Broadcasting, type promotion: for example, “mul” is a binary generator, and the two operands can have different shapes and dtypes. ML frameworks often improve usability by providing implicit promotion to a common element type, and support broadcasting of elements.
Layout munging: some frameworks support multiple different layouts, e.g., row-major and col-major, tiled layouts, and the like. When the inputs are in different formats, a conversion may be needed. Some libraries use strides to provide a common implementation that can work with many different layouts, but strides are not general to tiled layouts.
Type dispatch: standard kernel libraries work on multiple dtypes, which are only known dynamically at kernel invocation time. This requires the kernel to dynamically dispatch over the dtype and dispatch to kernels specialized for many different dtypes. Some dtypes may have special cases, e.g., “complex add” can be handled by the same code path as “scalar add” (since complex addition is element wise), but “complex mul” is a completely different algorithm than “scalar mul”.
Thread Tiling: At the outer level of the type-specific kernel algorithm, the computation is carved into blocks that can be executed in parallel by multiple threads. The size of each subunit needs to be determined, and is generally best evaluated based on hardware characteristics and size of input data (not based on #available threads).
Cache Tiling: Within the per-thread computation, the computation is typically cache blocked, e.g., at the L2 level. The size of the L2 is target specific. It may be important for algorithms that make multiple passes over the data, and less important for element-wise operations that have little reuse.
Per Tile Algorithms: Within the per-L2 tiles, there are many ways to implement the core algorithm, including with scalars, vectors, using prefetches, and the like. There are also special cases that are interesting to handle when broadcasting is handled internally to the kernel, e.g., when the fastest varying dimension of one operand is broadcasted.
Many microkernels: Algorithms like matrix multiplication depend on lower-level operations like memset to clear buffers, panel dot products, reductions, and the like. These “microkernels” are themselves implementable in many different ways.
Macro algorithms: Many generators have multiple completely different algorithms for computing the result, e.g., in convolution we see the im2col approach, direct convolution, Winograd. Matmul has many implementations (particularly when quantization and accelerators force weird data layouts), also including Strassen's algorithm, and the like.
Hardware targets now frequently have spatial operations (like Apple AMX or Intel AMX) that can speed up multiple loop nests at a time, e.g., for matrix multiplication and large element wise blocks. They also have many architectural families that will want things register-blocked, pipelined, and unrolled differently.

In some examples, the primitive-level representation of a kernel 112 is a component of a framework comprised of a set of code generated kernels that operate on memory buffers such as, but not limited to, memory operators, 1D memory arrays, tensor buffers, user defined data structures, and the like. In some examples, kernels directly use C/C++, assembly, and intrinsics for specific hardware features.

In some examples, a library of kernel components is utilized to generate additional kernels. For example, buffer-level operators are utilized that replace legacy kernels. The kernel components are modular and reusable, including core algorithms such as, but not limited to, memory fills, reductions, element wise operators, and the like. in addition to more specialized primitives used in quantized kernels and other domains.

In some examples, generators are parametric generators. It is difficult for humans to create and maintain all permutations of a kernel by hand (e.g., for all dtypes, all target machines and the like.), so they pervasively turn to meta programming. This meta programming comes in a variety of forms, for example C macros and ifdefs, Python generator frameworks, “emitters” written in C++ against “IRBuilder” compiler APIs, but the most widely used are C++ templates.

In some examples, kernels are defined as declarative generators that take kernel parameters and have arbitrary imperative logic coded against them that is “burned into” the generated code for a kernel. This can be used to specialize on things like the dtype, unroll factors, vector lengths, cache sizes, and the like. Most parameters have integer type and are bounded by range (e.g., unroll<=8 times), a list of valid values (e.g., vector length=2, 4, 8, 16, 32), and should support enums (e.g., consider dtype), which makes them searchable. Using generators still permits use of concrete kernels (e.g., a fixed blob of assembly) since they are a valid generator with no parameters (or, equally, fully constrained parameters).

Example code is illustrated below. A kernel may have parameters bound at its invocation site, e.g., after a dynamic switch on dtype, the next-level down microkernel is invoked with a dtype parameter bound to a constant value:

```
// This fills a 1D buffer with unknown length but
known dtype with ones.
kgen.generator.interface
@fillWithOnesFixedDType<type: dtype>(%dest: !meta
.buffer<?xtype>)
// Fills a 1D buffer with unknown length and
unknown dtype with ones.
kgen.generator @fillWithOnes(%dest: !meta.buffer<
?x?>) {
  %dtype
= meta.buffer.dtype %dest : !meta.buffer<?x?>
  scf.switch %dtype { // dynamic switch
  case f32:
    %dstCast = meta.buffer.cast %dest
: !meta.buffer<?x?> to buffer<?xf32>
kgen.call @fillWithOnesFixedDType<type: dtype = f
32>(%dstCast)
  case i32:
    %dstCast = meta.buffer.cast %dest
: !meta.buffer<?x?> to buffer<?xi32>
kgen.call @fillWithOnesFixedDType<type: dtype = i
32>(%dstCast)
  case i8:
    %dstCast
= meta.buffer.cast %dest : !meta.buffer<?x?> to b
uffer<?xi8>
kgen.call @fillWithOnesFixedDType<type: dtype = i
8>(%dstCast)
  // ..
  }
}
```

FIG. 2 is a block diagram of a compilation system 200a, in accordance with some examples. A compilation system 200a generates software objects, such as kernels, using a kernel definition 140. The kernel definition 140 comprises a parameterization 136 and one or more generators 132. The compilation system 200a uses generated kernels 208 and hand-written kernels 210 to generate executable objects 216 in a binary executable format (BEF) BEF 218 using the generated kernels 208 and the hand-written kernels 210. The compilation system 200a uses a kernel generation method 300 to generate a kernel using the kernel definition 140.

In some examples, an executable object 216 in a binary executable format 218 including one or more kernel objects 138 executes during a runtime 212 on a set of hardware 214 devices and generates execution metrics 142 that are used to optimize generator configurations in order to optimize kernels.

FIG. 3 is an activity diagram of a kernel generation method and FIG. 4 is a generator elaboration method 400, in accordance with some examples. A compilation system 200a uses a kernel generation method 300 to compile or generate a kernel. Although the kernel generation method 300 and the generator elaboration method 400 depict a particular sequence of operations, the sequence may be altered without departing from the scope of the present disclosure. For example, some of the operations depicted may be performed in parallel, in a different sequence, or a different component of a composable kernel compilation system, such implementations do not materially affect the generator of the elaboration process. In other examples, different components of an example device or implementation of the compilation system 200a may perform operations at substantially the same time or in a specific sequence.

In operation 302, the compilation system 200a receives a kernel definition 140 comprising a parameterization 136 and one or more generators 132 that comprise coding logic that defines a kernel. In some examples, the code comprises generator code written in a general purpose programming language.

In operations 304 and 306, the compilation system 200a, for each generator, determines an optimal configuration of the generator using the parameterization 136 in a process more fully described in reference to FIG. 4.

In operation 308, the compilation system 200a generates a primitive-level buffer-semantic representation of the generator using the optimal configuration of the generator. For example, the compilation system 200a lowers the generator to the primitive-level buffer-semantic representation through successive compilation passes using one or more intermediate representations.

In operation 310, the compilation system 200a adds the primitive-level buffer-semantic representation of the generator to a set of primitive-level buffer-semantic representations of the generators. The set of primitive-level buffer-semantic representations of the generators are used to compose primitive-level buffer-semantic representation of a kernel.

In operation 312, the compilation system 200a composes a primitive-level buffer-semantic representation of kernel corresponding to the input generator using the set of primitive-level buffer-semantic representations of the generators. For example, the compilation system 200a takes the set of primitive-level buffer-semantic representations of the generators and code slices the primitive-level buffer-semantic representations of the generators and their dependencies into a single module or kernel.

In operation 314, the compilation system 200a lowers the single module to one or more object (.o) files and stores the one or more object files of the kernel in a datastore such as, but not limited to, a CAS or the like, of generated kernels 208. In some examples, the object file has a format of an object file that a standard C-style toolchain would produce, and so works seamlessly with stacks that implement a C/C++ Foreign Generator Interface (FFI).

FIG. 4 is an activity diagram of a generator elaboration method 400, in accordance with some examples. A compilation system 200a uses the generator elaboration method 400 to generate permutations of configurations of generators that are evaluated by the compilation system 200a to determine an optimal configuration of a generator. Although the generator elaboration method 400 depicts a particular sequence of operations, the sequence may be altered without departing from the scope of the present disclosure. For example, some of the operations depicted may be performed in parallel, in a different sequence, or a different component of a compilation system 200a, such implementations do not materially affect the generator of the elaboration process. In other examples, different components of an example device or implementations of the compilation system 200a may perform operations at substantially the same time or in a specific sequence.

In operation 402, the compilation system 200a searches for an optimal configuration of a generator using an evaluator associated with the generator. The kernel compiler 206 is capable of performing a static analysis search and a dynamic analysis search for an optimal configuration of a generator. In a static analysis search, the kernel compiler 206 uses a search component 102 to search through several different types of datastores. One type of datastore is a cache 128 containing optimal configurations of generators that can be reused by the kernel compiler 206 to determine an optimal configuration of a generator when lowering a generator during a compilation process. The cache 128 can be a local cache or a distributed cache distributed across remote storage nodes on one or more servers. For example, the compilation system 200a maintains a datastore of optimal configurations in the cache 128. The search component 102 looks for an optimal configuration for the generator using the evaluator which is a metric by which the search component 102 decides that a configuration of the generator is optimal.

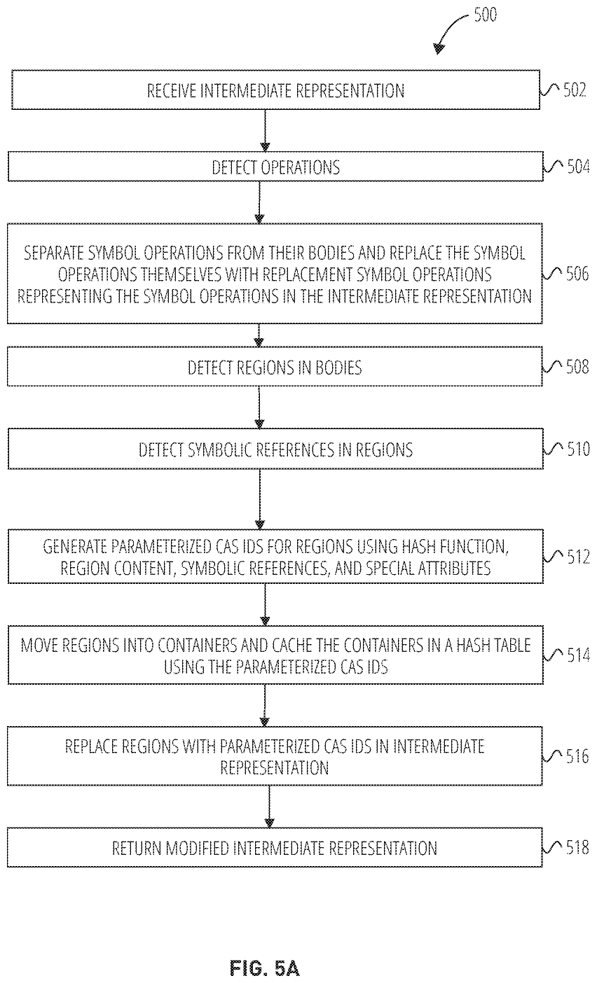

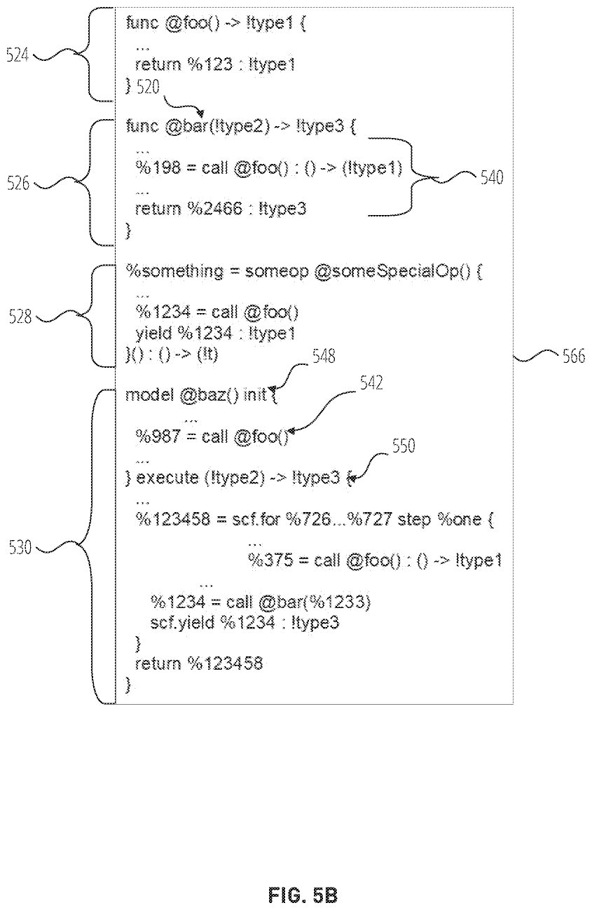

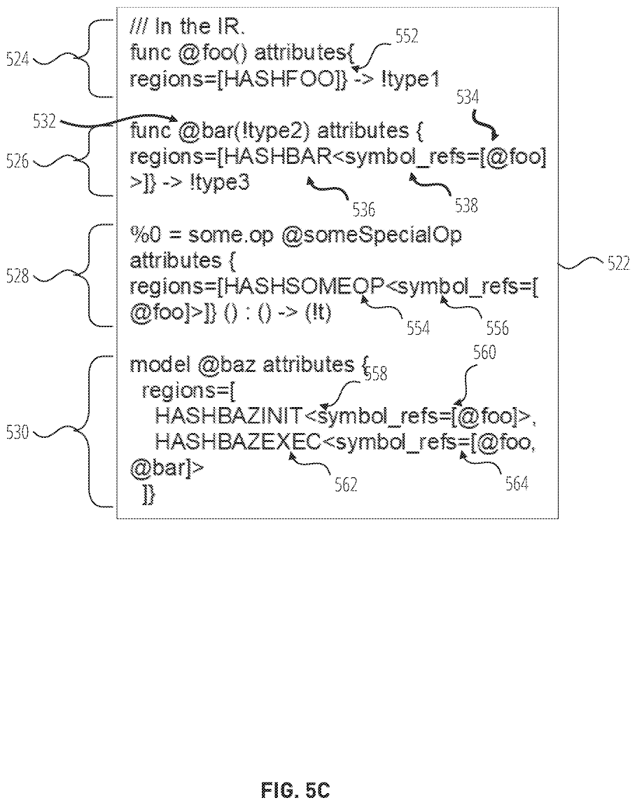

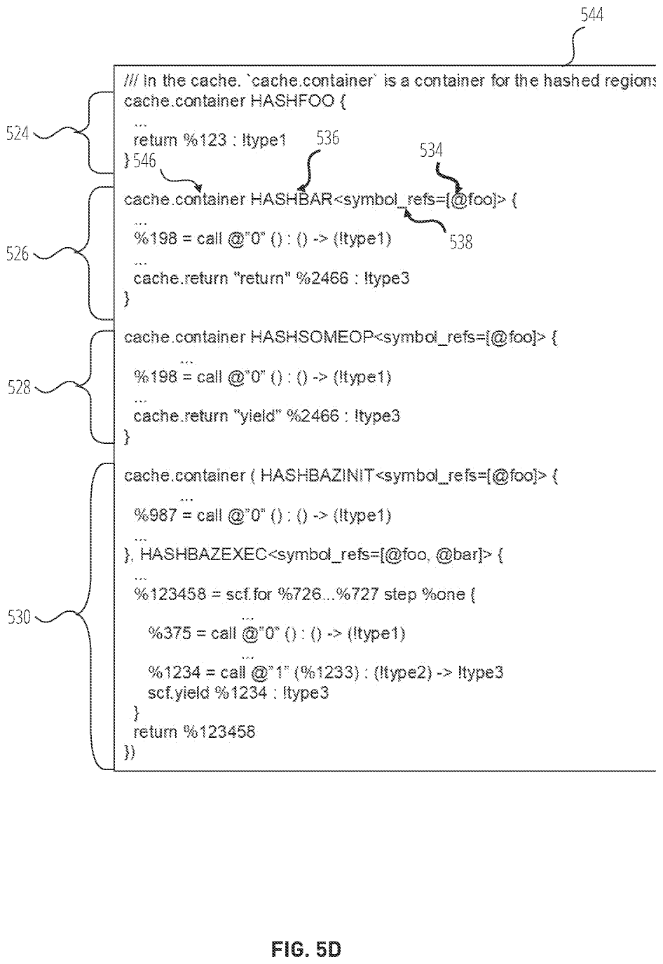

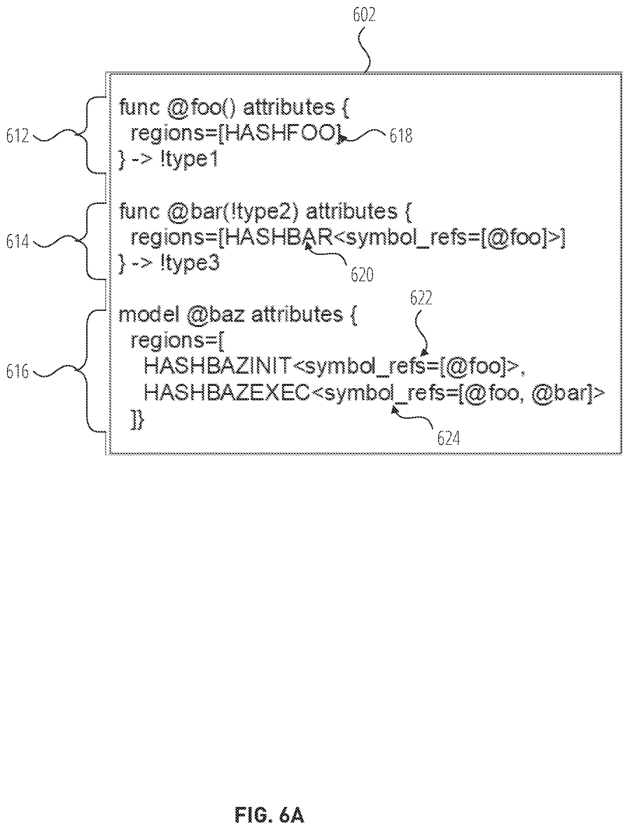

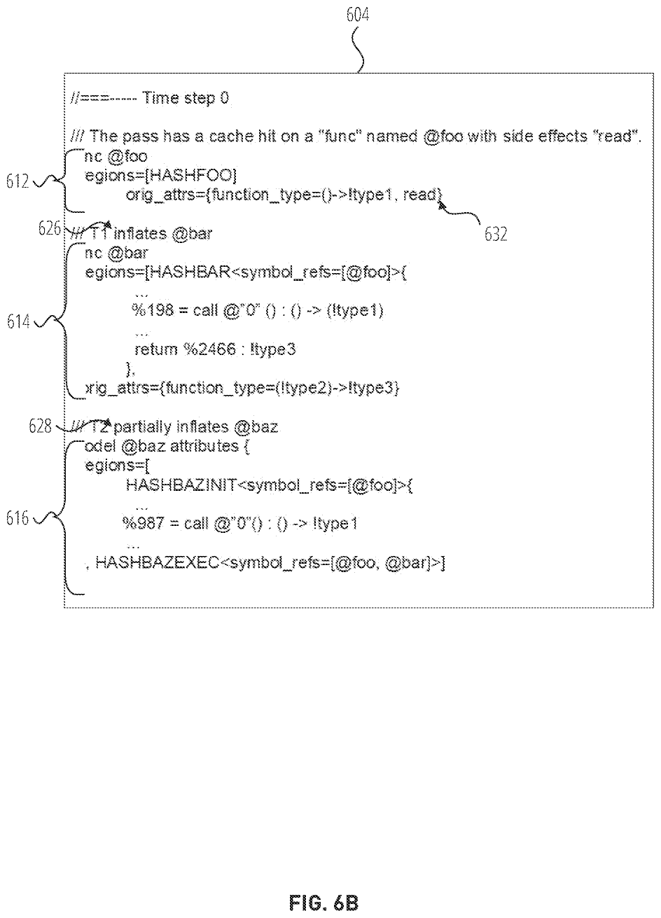

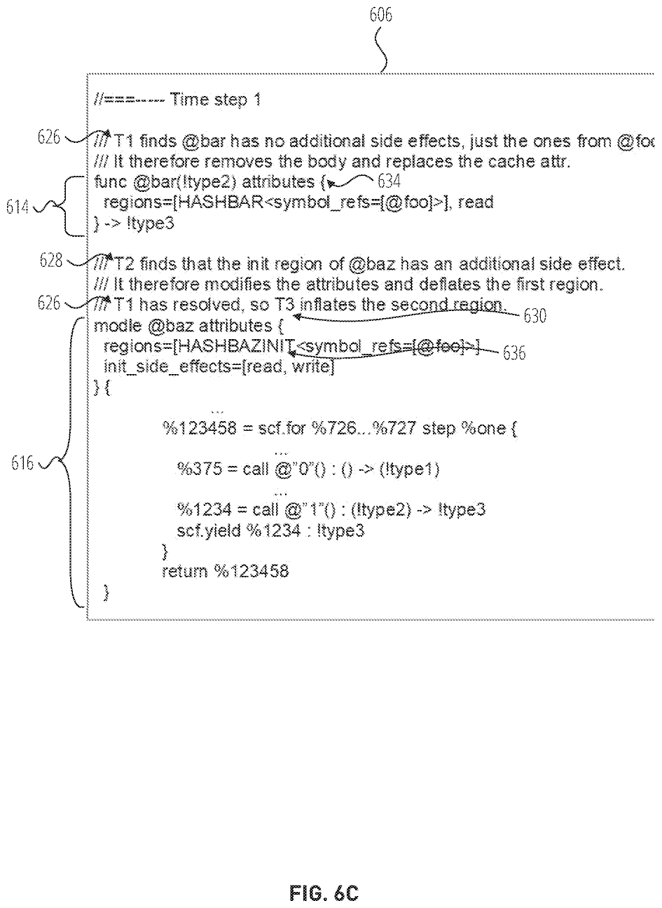

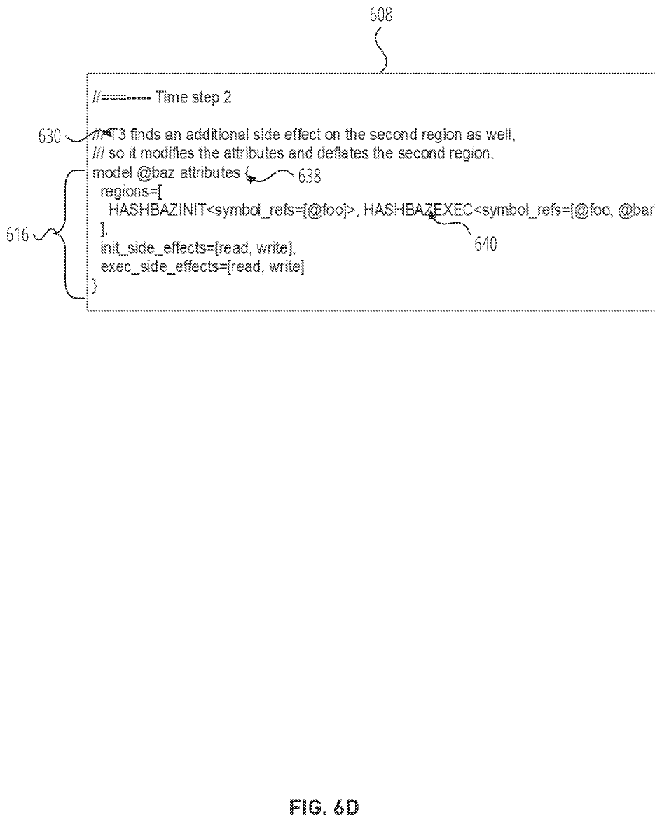

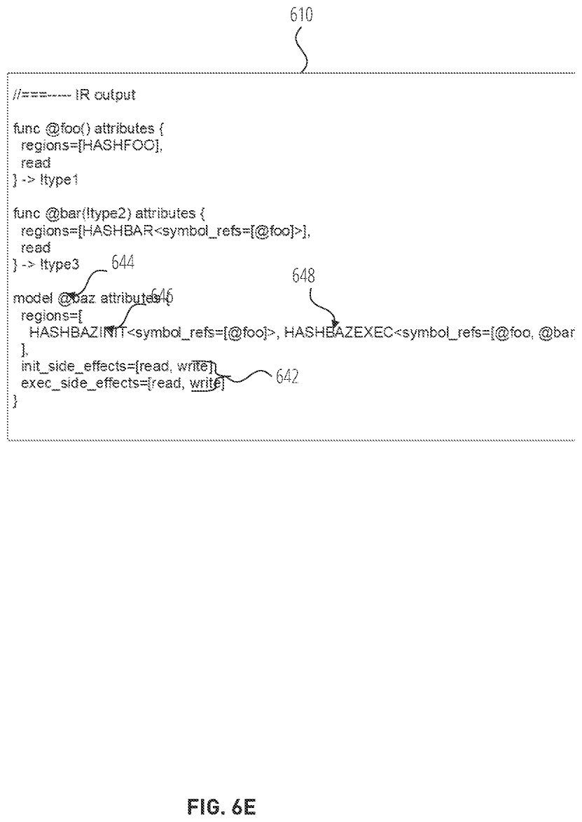

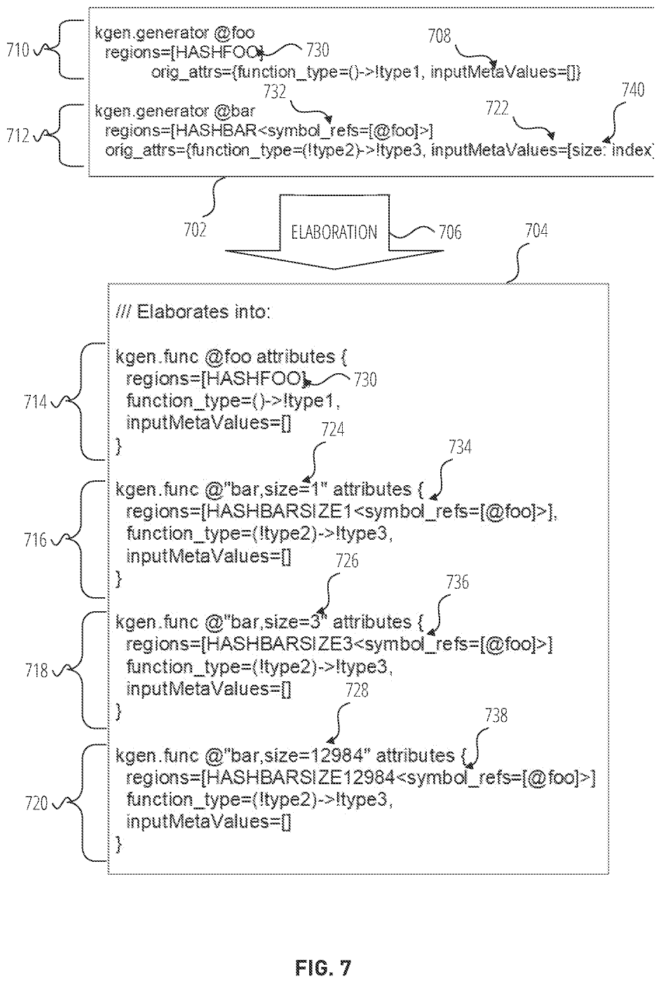

In some examples, a cache comprises a hash table. The hash table comprises regions of intermediate representations of operations generated using generators. The regions of intermediate representations are stored in the hash table using a parameterized CAS ID as more fully described in reference to FIG. 5A, FIG. 6A, and FIG. 7.

In operation 404, the compilation system 200a determines if an optimal configuration was found during the search of the cache 128.

In response to determining that an optimal configuration of the generator was not found during the static analysis search, the kernel compiler 206 performs a search using a dynamic analysis of the generator. To do so, in operation 406, the kernel compiler 206, generates a set of configurations. For example, the compilation system 200a generates an intermediate representation of the generator. The compilation system 200a uses the intermediate representation of the generator and the parameterization 136 to generate one or more configurations of the generator as one or more test intermediate representations of the generator.

In operation 408, the compilation system 200a generates a set of executable test functions using the one or more test intermediate representations. For example, for each test intermediate representation, the compilation system 200a lowers the test intermediate representation into an executable object in a BEF to generate the executable test function.

In operation 410, the compilation system 200a executes the set of test functions to determine a set of respective performance scores. For example, the composable kernel compilation system executes each test function and monitors the test function's performance as the test function operates on a test suite of data. In some examples, the performance score comprises an initialization score indicating an amount of time used by the test function during an initialization of the test function. In some examples, a performance score comprises an execution score indicating an amount of time that the test function takes to operate on the test data set. In some examples, the performance score includes an amount of time that a test function communicates with other generators of a kernel during execution.

In operation 412, the compilation system 200a selects an optimal configuration of the set of configurations using the set of respective performance scores. For example, the kernel compiler 206 assigns a weight to each set of generator, configuration, and performance data. During selection, the compilation system 200a selects a configuration of a generator using the sets of function, configuration, and performance evaluation data and their associated weights.

In operation 414, the compilation system 200a generates an intermediate representation of the generator using the optimal configuration.

In operation 416, the compilation system 200a caches the optimal configuration of the generator in cache for later search processes. For example, a cache comprises a hash table. The hash table comprises regions of intermediate representations of operations generated using the optimal configurations of the generators. The regions of intermediate representations are stored in the hash table using a parameterized CAS ID as more fully described in reference to FIG. 5A, FIG. 6A, and FIG. 7.

In operation 418, the compilation system 200a returns the optimal configuration of the generator.

In some examples, generating the set of configurations is further based on a target machine parameterization.

In some examples, the set of test functions are executed on a plurality of machines.

In some examples, the performance scores include a set of an execution time and a loading time.

In some examples, generating the set of test functions includes selecting a library of generator configurations from a set of libraries using the configuration, and generating a test function of the set of test functions using the selected library and configuration.

In some examples, the set of libraries includes a set of user-defined libraries and a set of system-defined libraries.

In some examples, the generator configurations in the set of libraries are stored in an intermediate language.

In some examples, the generators are initially defined in a programming language other than the general purpose programming language and lowered to the intermediate language.

In some examples, the cache 128 is searchable using a generator parameterization and a target machine parameterization.

In some examples, determining the configuration of the generator includes searching the cache 128 using the parameterization and the target machine configuration to find the optimal configuration of the generator.

In some examples, the cache 128 is distributed across multiple storage nodes and the searching is performed on the distributed storage nodes.

In some examples, a set of runtime performance data collected from a set of executed functions during execution is stored in the cache 128 where each executed function is associated with a known configuration of a generator and a known generator parameterization.

In some examples, the performance data includes communication data of communications between a subset of the executed functions.

In some examples, determining a configuration of the generator includes determining a configuration using a machine learning model of an AI component 104 trained on a set of runtime performance data collected from a set of executed functions during execution, where each executed function is associated with a known configuration and a known parameterization.

In some examples, translating the generator code, determining the configuration, generating the executable object, and composing the kernel are performed on two or more machines.

In some examples, a primitive-level representation of a kernel 112 is stored in a datastore accessible through a network.

In some examples, the primitive-level representation of a kernel 112 is combinable with other kernels in a kernel library.

In some examples, there is no dependence between one or more generators of a kernel, so the compilation system 200a can process the generators in parallel. This structure (along with the general tree/forest/DAG structure of the computation) contributes to a compilation process for kernels having parallelism that may be exploited to speed up kernel generation on one or more multicore machines.

In some examples, kernel authors declare their own abstractions, as in C++. To do so, a compilation system 200a provides for declaring interfaces to (micro) kernels, and supports having many different implementations for each micro-kernel—each of which implements the common interface. Each kernel may be defined recursively using simpler smaller kernels, which can themselves have multiple different implementations.

In some examples, there are multiple available implementations of each kernel, microkernel, generator, and generator, the compilation system 200a determines which one is optimal for a given target and scenario (dtype, size class and the like). Accordingly, a (micro) kernel interface declaration defines a cost model that is optimized by search (e.g., find configuration of an implementation with the “best achieved FLOPS”). For example, an implementation of a microkernel may include using scalar operations, implemented with SIMD generators of multiple different lengths, a few implemented in inline assembly, and maybe one implemented with Apple AMX. The compilation system 200a selects a configuration for implementation with the highest throughput for the current hardware, empirically, by measuring it (implementations for incompatible systems are ignored as infinite cost).

In some examples, search is enabled by building up a large collection of executable objects 126 that use the generators in realistic ways. This allows the compilation system 200a to collect data of one or more execution metrics 142. For example, metrics are collected of an executable object 126 comprising a model. The metrics comprise tensor input sizes and execution time metrics (using realistic input dimensions instead of random ones) similar to the mmperf “benchmark sizes” lists. In some examples, a profile is collected and used, or certain dimensions are weighted more heavily to achieve goals like “prioritize MLPerf performance” or “generate best possible code for one model,” depending on any particular product's goal.

In some examples, parameters of the parameterization 136 are unspecified. These parameters are explored and determined by the compilation system 200a during a search. For example, the compilation system 200a determines a number of iterations that will fit in a cache, and the compilation system 200a returns the result as a parameter result, allowing the enclosing generator to tile or parallelize around that. As another example, given an element-wise multiply microkernel implemented in terms of vectors over a 1D block of memory, a loop utilizing one of these low level generators will increase in FLOPS until the L2 cache is exceeded, at which point a cache blocked algorithm above will typically be more efficient. Allowing the kernel to define the metric (e.g., FLOPS) will allow the use of search to find the right implementation. Top level generator kernels can use latency as their metric.

In some examples, as some generator parameters (e.g., dtype) are defined on the generator interface (and thus common to all implementations), the compilation system 200a provides for implementations of a generator to have additional parameters as well (e.g., an ARM implementation of a kernel providing three implementations of the same generator for different microarchitectures). This would be sugar for “flattening” these parameters as different individual implementations of the same microkernel.

In some examples, there are multiple implementations of each micro-kernel, which are then implemented in terms of other interfaces which may have many implementations. These expansions form a tree of possible expansions, and, as there may be many top level generators in the framework, there is a forest of expansions to work with at many levels of abstraction. For example, a matrix multiplication microkernel can be implemented with a three-level for loop, with cache blocking, and with internal L2 tiling. It may also be implemented it to use target specific dot product operations, and with 2D generators and common accelerators. Each of these may be implemented in independently of each other, all implementing the same interface. Each “tree of expansions” may have an exponential number of expansions possible for a single framework generator. This makes it impractical to search the entire space for a single kernel, and even more challenging to support an entire ML framework-particularly when a single framework may have hundreds/thousands of individual kernels.

In some examples, human-authored constraints are defined on the kernels to cut off the search space or guide the exploration as a basic bound in parameter declarations. In some examples, conditional constraints are provided. In some examples, redundancy in the tree-based structure is exploited with dynamic programming techniques. Dynamic programming uses memoization/caching of subproblems to algorithmically improve the performance of hierarchical tree-based algorithms. In some examples, each tree of expansions will have a lot of common leaves, and a forest will have many shared leaves, subtrees, and potentially entire kernels. By allowing a cost model to be defined at many levels (not just at the top level framework generator), the compilation system 200a exploits modularity for searches and can caches the results. The use of dynamic programming collapses the “expansion tree” into a Directed Acyclic Graph (DAG).

In some examples, a cache is hosted on a cloud service, providing an oracle for users so they have access to previously searched algorithms offline. This allows users to avoid full search algorithms on their device. In some examples, the compilation system 200a generates analytics on what users are using the compilation system 200a for. In some examples, an install size for a mobile framework may be very small, instead of shipping a typical kernel library with lots of bloated kernels, a provider of a compilation system 200a ships a Just In Time (JIT) compiler that can generate the kernels. A user might not want to do a search on their device, so a provider of a compilation system 200a can either bundle a binary blob with the application or add logic to download the right kernel parameters for the target hardware and generate/cache machine code for the kernels at app install time, using the compiler as a “compression scheme” to reduce the download size impact of the kernel library.

In some examples, each level of generator tree expansion is functional (side-effect free), and the “key” used to look up the computation is encodable is a way the compilation system 200a can hash and lookup the result of the transformation (e.g., the key is a blob of serialized MLIR). This is useful for parallelizing the tree compilation (tree/DAGs have a lot of parallelism).

In some examples, kernel fusion of arbitrary element-wise computation into matrix multiplication is enabled. The compilation system 200a supports this by allowing generators to be parameterized by regions. Regions are just a different form of parameter argument, where a body of code is passed down and is accessible to meta programming constructs. For example, exposing regions as a general feature in the compilation system 200a system allows for operations such as “switch on dtype” and “statically unroll the loop using this parametric expression” to be defined in the system itself, rather than being hard coded into the system. This allows the compilation system 200a to be user-extensible as nothing in the stack is specific to dense linear algebra, users can build their own library of generators that partition work against tables of data or trees, talk to their own foreign storage (e.g., databases and the like), and the like.

In some examples, the compilation system 200a utilizes algorithmic skeletons allowing describing higher order transformations that enable encoding parallel patterns in a reusable way as an implementation task is simplified by the fact that each skeleton may be considered independently, in contrast to the monolithic programming interfaces of existing systems at a similar level of abstraction.

In some examples, generators are allowed to be partial generators from the interface declaration to a concrete implementation. Constraints indicate limitations on their parameters, e.g., “this implementation only works with dtype=float32”, or “this only works on machines with X86 VNNI extension”, this “works for sizes modulo 136”, and the like. In some examples, are upward propagated from kernel implementations out to the generator graph.

In some examples, the compilation system 200a uses kernel descriptions in intermediate representation form, a machine analyzable/transformable format. In some examples, the compilation system 200a extracts shape generators for generators by using code slicing to extract the computation from the kernel description. This ensures that the compilation system 200a has a single source of truth for kernels+shape generators.

In some examples, the compilation system 200a implements generators with a Multi-Level Intermediate Representation (MLIR) compiler APIs to provide structures that are more complex than parameterized expansions. Generators are encoded as compiler transformations and provide a flexible programming model to users. These are generators that take a region of an intermediate representation as a parameter and produce a new one.

In some examples, the compilation system 200a extracts metadata about the operations, e.g., whether they are associative, generate side effects, and the like.

In some examples, kernels generated by the compilation system 200a take output buffers as arguments that may not be exposed into the graph. The compilation system 200a provides for a “buffer exposed” graph-level representation that allows memory planning, in-place optimizations for concatenation, and the like.

In some examples, the compilation system 200a takes metadata of buffer-level generator implementations and reflects it back up to the generator graph level.

In some examples, the compilation system 200a employs a Python-like language that is a user-extensible hybrid declarative/imperative programming language that allows expressing arbitrary MLIR generator graphs in a usable way.

FIG. 5A is an activity diagram of a caching method 500, in accordance with some examples. FIG. 5B illustrates an intermediate representation 566 of a program, FIG. 5C illustrates a modified intermediate representation 522 having parameterized CAS IDs replacing cached regions of the intermediate representation 566, and FIG. 5D illustrates a structure of a cache 544, in accordance with some examples.

Although the example caching method 500 depicts a particular sequence of operations, the sequence may be altered without departing from the scope of the present disclosure. For example, some of the operations depicted may be performed in parallel or in a different sequence that does not materially affect the function of the caching method 500. In other examples, different components of the compilation system 200a may perform operations at substantially the same time or in a specific sequence.

The intermediate representation 566 comprises one or more components, such as a model, namely model “baz” 530, and a set of operations, namely function “foo” 524, function “bar” 526, and an operation “someop” 528. A memory footprint of the intermediate representation 566 is almost entirely in the bodies, such as body 540, of the operations and the compilation system 200a caches just the regions of modified intermediate representation 522 hanging off these operations as a goal of the compilation system 200a is to recompile just the parts of the program of the intermediate representation 566 that have changed since the last time the program was compiled.

In operation 502 of FIG. 5A, the compilation system 200a receives the intermediate representation 566.

In operation 504, compilation system 200a detects one or more operations of the intermediate representation 566. For example, compilation system 200a parses intermediate representation 566 to detect portions of the intermediate representation 566 indicating the start of a definition of an operation such as, but not limited to, the strings “func”, “%”, “model”, and the like.

In operation 506, for each of the components of the modified intermediate representation 522 (e.g., function “bar” 526), the compilation system 200a separates the symbol operation (e.g., symbol operation 520) of the operation from its body (e.g., body 540) and replaces the symbol operation itself with a replacement symbol operation (e.g., replacement operation 532) in the modified intermediate representation 522 that represents the symbol operation 520 in the intermediate representation 566.

In operation 508 the compilation system 200a determines a set of regions in the bodies of the operations. For example, function “foo” 524 does not reference any other function so function “foo” 524 comprises a single region, namely the body of function “foo” 524. The function “bar” 526 comprises a single reference to the function “foo” 524 so function “bar” 526 comprises one region, namely the body of function “bar” 526. In a similar manner, the body of operation “someop” 528 comprises a single region. The model “baz” 530 comprises two regions as indicated by an “init” region 548 comprising a reference to function “foo” 524, and a “execute” region 550 region, comprising a called to function “foo” 524 and to function “bar” 526.

In operation 510, the compilation system 200a detects calls in the regions. For example, the single region of function “foo” 524 does not comprise any calls. The single region in function “bar” 526 comprises a reference to function “foo” 524. The single region of the operation “someop” 528 comprises a reference to function “foo” 524. The “init” region 548 of model “baz” 530 comprises a call 542 to the function “foo” 524. The “execute” region 550 of model “baz” 530 comprises a reference to function “foo” 524 and a reference to operation “someop” 528.

In operation 512, the compilation system 200a generates a respective parameterized CAS ID for each of the regions using a hash function, a content of the region, and the detected calls. For example, for function “foo” 524, the compilation system 200a generates parameterized CAS ID 552 by hashing the contents of the single region of function “foo” 524 to create “HASHFOO”. The function “foo” 524 does not reference any other functions, so there are no symbolic references in the parameterized CAS ID 552.

For function “bar” 526 the compilation system 200a hashes the content of the single region of function “bar” 526 to create hash “HASHBAR” of parameterized CAS ID 536. The function “bar” 526 calls function “foo” 524 so the compilation system 200a adds a reference to function “foo” 524 to symbolic references 538.

For operation “someop” 528, the compilation system 200a hashes the content of the sole region of operation “someop” 528 to generate hash “HASHSOMEOP” and adds it to parameterized CAS ID 554. The operation “someop” 528 calls function “foo” 524 so the compilation system 200a adds a reference to function “foo” 524 to symbolic references 556.

Model “baz” 530 comprises two regions, “init” region 548 and “execute” region 550. Compilation system 200a generates parameterized CAS ID 558 for “init” region 548 and parameterized CAS ID 562 for “execute” region 550. Compilation system 200a hashes the content of the “init” region 548 to generate hash “HASHBAZINIT” that is added to parameterized CAS ID 558. As “init” region 548 comprises a reference to function “foo” 524, references to function “foo” 524 are added to symbolic references 560 of parameterized CAS ID 558. In a similar manner, compilation system 200a hashes the content of “execute” region 550 to generate hash “HASHBAZEXEC” that is added to parameterized CAS ID 562 and references to function “foo” 524 and function “bar” 526 are added to symbolic references 564 of parameterized CAS ID 562.

In operation 514, the compilation system 200a copies or moves the content of the regions into respective containers, such as cache container 546, that are cached in a hash table using respective parameterized CAS IDs as keys in the hash table.

In operation 516, compilation system 200a replaces regions of the operators with their respective parameterized CAS IDs. For example, the region of function “foo” 524 is replaced with parameterized CAS ID 552, the region of function “bar” 526 is replaced with parameterized CAS ID 536, the region of operation “someop” 528 is replaced with parameterized CAS ID 554, and the two regions of model “baz” 530 are replaced with parameterized CAS ID 558 and parameterized CAS ID 562.

In operation 518, compilation system 200a returns the modified intermediate representation 522.

In some examples, each region has a list of the symbols that it references, such as referenced symbol 534, and indices into this list are used in the symbolic references 538. In some examples, because symbolic references can be used anywhere, including for other attributes, a special attribute is used to reference a region meta parameter that may be a symbol binding or the like. In some examples, symbolic references may be used for other attributes such as, but not limited to, a constant data hash.

In some examples, a user chooses how to parametrize a parameterized CAS ID at a more fine-grained level. In some examples, a dialect interface is provided that the user can specialize to convert an attribute into a symbolic attribute that the caching code converts from one arbitrary attribute into an index into the top level parameter list on the parameterized CAS ID.

The use of a parameterized CAS IDs and parameterized hashes natural representation that preserves the call graph. The symbols that have calls (and therefore callees) are parametrized on the callees, so if the callee changes in a way that doesn't affect the caller, the caller doesn't need to be recompiled. This increases the cache hit rate and effectively truncates a traversal.

In some examples, performing an analysis or performing a transformation entails inflating the modified intermediate representation 522 back to its original state. This operation is easily reversible, and as the IR is cached in a hash table, the compilation system 200a inflates only the operations that the compilation system 200a uses for performing the analysis or transformation.

In some examples, operations without regions are not cached as the bodies of various regions will be a majority of operations in an intermediate representation.

In some examples, the caching method 500 method is fully recursive. For example, a SymbolTable operation contains symbols, the compilation system 200a can cache a region of the SymbolTable and the parameterized CAS ID is a parametric on the symbols that the region contains. The cached object will have references to symbols rather than a call to a symbol—and will expand into the cached symbol rather than a call operation.

FIG. 6A to FIG. 6E illustrate a transformation of an intermediate representation during a distributed side effect analysis process, in accordance with some examples. FIG. 6A illustrates a cached intermediate representation 602, FIG. 6B illustrates portions of the intermediate representation at a time step 0 604, FIG. 6C illustrates portions of the intermediate representation at a time step 1 606, FIG. 6D illustrates portions of the intermediate representation at a time step 2 608, and FIG. 6E illustrates an output intermediate representation 610, in accordance with some examples. The use of parameterized CAS IDs provides for cache-aware transforms. For example, a side-effect inference pass or Call Graph Strongly Connected Component (SCC) pass in LLVM.

FIG. 6A illustrates an intermediate representation 602 having two functions, function “foo” 612 and function “bar” 614, and a model “baz” 616. Regions of the function “foo” 612, the function “bar” 614, and the model “baz” 616 are cached with the cache locations pointed to by parameterized CAS ID 618, parameterized CAS ID 620, parameterized CAS ID 622, and parameterized CAS ID 624.

The side-effect inference pass runs bottom-up on the call graph. It is able to read from the cache a previous analysis of function “foo” 612 by using the analysis to be performed as the key, and the side effect attributes as the value in the hash table. After this, side-effect inferences are run for three regions, a body of function “bar” 614 as indicated by parameterized CAS ID 620, and two regions of model “baz” 616, as indicated by parameterized CAS ID 622 and parameterized CAS ID 624. In some examples, the side-effect inference pass runs are parallelized and thus have multiple processes performing inference, for example Task 1 (T1) 626 performing inference on the body of function “bar” 614, Task 2 (T2) 628 performing inference on the first region of model “baz” 616 and Task 3 (T3) 630 performing inference on the second region of model “baz” 616. T1 and T2 can be run in parallel, and T3 depends on T1.

At time step 0 604, the pass has a cache hit on function “foo” 612 with side effect “read” 632. Task 1 (T1) 626 inflates function “bar” 614. And Task 2 (T2) 628 partially inflates model “baz” 616.

Referring to FIG. 6C, at time step 1 606 Task 1 (T1) 626 finds function “bar” 614 has no additional side effects, just the ones from function “foo” 612 (of FIG. 6B). Task 1 (T1) 626 therefore removes the body of function “bar” 614 and replaces the cache attributes 634.

Task 2 (T2) 628 finds that an initialization region of model “baz” 616 (as exemplified by parameterized CAS ID 636 “HASHBASINIT” has an additional side effect. Task 2 (T2) 628 therefore modifies the attributes and deflates the first region. Task 1 (T1) 626 has resolved, so Task 3 (T3) 630 inflates the second region of model “baz” 616.

Referring to FIG. 6D, Task 3 (T3) 630 finds an additional side effect on the second region of model “baz” 616 as well, so Task 3 (T3) 630 modifies the attributes 638 and deflates the second region of model “baz” 616 as exemplified by parameterized CAS ID 640 “HASHBAZEXEC”.

Referring to FIG. 6E, output intermediate representation 610 illustrates all the side effect attributes can be cached by combining the analysis performed (side-effect-inference) with the symbol operation 644 name for the parameterized CAS ID 646 and parameterized CAS ID 648, and keeping the result attributes as the values 642.

In some examples, as a caching transform is fully reversible, integrating a transform that is not cache-aware can be achieved by inflating the relevant sections before running the pass. In some examples, a legacy pass can be treated as a black box by keying off operations that have the region attributes that it operates on combined with the pass name and simply caching its output.

FIG. 7 illustrates an elaboration of a generator, in accordance with some examples. An elaborator component of a compilation system, such as compilation system 200a, can perform an elaboration of a generator during a search for an optimal configuration of the generator as described more fully in reference to FIG. 4.

In some examples, to perform an elaboration, the elaborator component makes a call-graph SCC pass in a bottom-up traverse of a call graph and expands generators into functions. In some examples, the elaborator component is made cache-aware, so as to take full advantage of the parallelism that can be gained through the use of a distributed cache employing parameterized CAS IDs. A cache-aware elaborator takes a deflated generator, possibly inflates it into the original generator, performs the expansion, and deflates the resulting functions. For example, generators 702 comprises two generators, a “@foo” generator 710 and a “@bar” generator 712. The generators comprise a parameterized CAS ID, such as parameterized CAS ID 730 and parameterized CAS ID 732, and a set of attributes including a set of input metadata, such as input metadata 708 and input metadata 722. During elaboration 706, the elaborator component generates a set of test functions 704, such as “@foo” test function 714, a first “@bar” test function 716, a second “@bar” test function 718, and a third “@bar” test function 720 using the attributes.

As the input metadata 708 of the “@foo” generator 710 contained an empty set of metadata, elaboration of the “@foo” generator 710 results in a single test function, namely “@foo” test function 714. As there is a single test function of the “@foo” generator 710, the parameterized CAS ID 730 of the “@foo” generator 710 is copied into the “@foo” test function 714.

However, as the input metadata 722 of the “@bar” generator 712 included an indexable size parameter 740 as part of the input metadata 722, the elaborator component generates a set of test functions, with each test function having a unique size parameter, such as size parameter 724, size parameter 726, and size parameter 728. As the regions of the bodies of the test functions are different, the regions are cached in a separate cache accessed using a parameterized CAS ID, as indicated by parameterized CAS ID 734, parameterized CAS ID 736, and parameterized CAS ID 738.

In some examples, a benefit to caching regions rather than operations with regions is that generator interfaces need not be cached. A generator interface does not have a body, and therefore doesn't need to be cached. A cache-aware elaborator component can detect a deflated generator that implement an interface, and, on a cache miss, can inflate the deflated generator into an original generator to perform search and/or expansion.

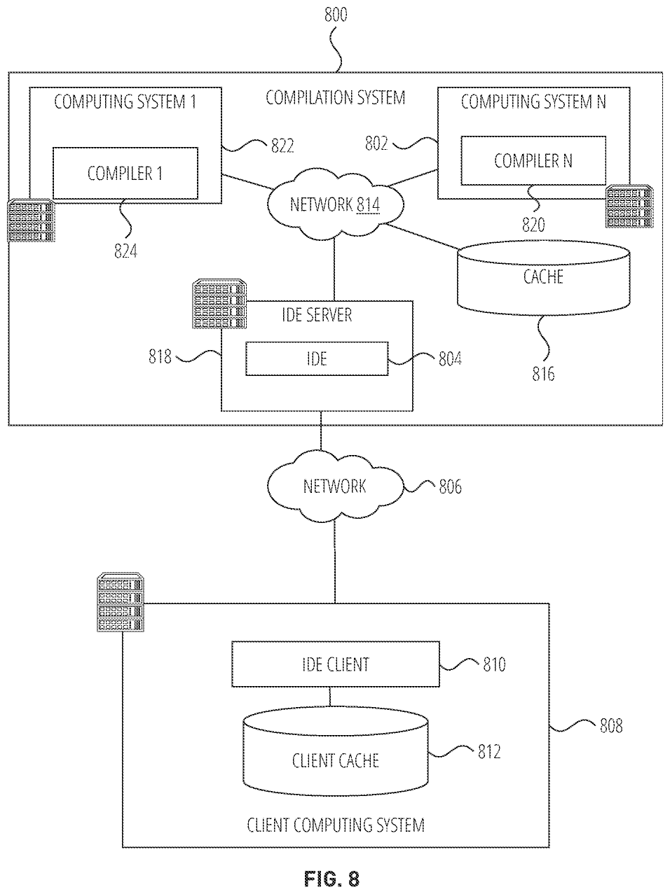

FIG. 8 is a collaboration diagram of a networked compilation system 800, in accordance with some examples. The compilation system 800 includes one or more computing systems, such as computing system 1 822 to computing system N 802 in communication via one or more networks, such as network 814. In some examples, the network 814 is a Local Area Network (LAN). In some examples, the network 814 is a Wide Area Network (WAN) such as the Internet or the like.

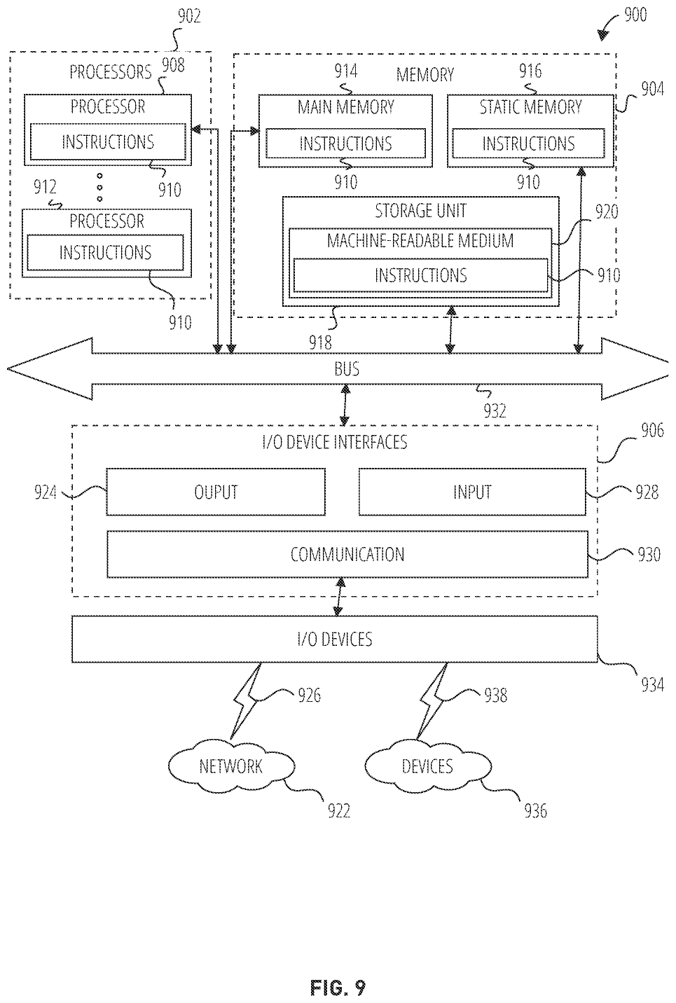

The computing systems comprise one or more computing machines, such as machine 900 of FIG. 9. The one or more computing systems hosts one or more compilers, such as computing system 1 822 hosting compiler 1 824 and computing system N 802 hosting compiler N 820. Each of the compilers are communicatively coupled, via one or more communication networks including a Local Area Network (LAN) 814, to other compilers of the compilation system 800 (e.g., hosted on respective other computing systems). A compiler can also communicate with locally hosted applications of their respective computing system using Application Program Interfaces (APIs).

The compilation system 800 further includes a cache 816 communicatively coupled to the compilers via one or more networks, such as the network 814.

The compilation system 800 further includes an Integrated Development Environment Server (IDE) 818 hosting an IDE 804. The IDE 804 is communicatively coupled to the compilers via one or more communication networks, such as the network 814.

A compiler interacts with other compilers and with the IDE 804 via the network 814. The data exchanged between the compilers and the IDE 804 includes functions (e.g., commands to invoke functions) and payload data (e.g., coding logic for compilation).

A client computing system 808 hosts an IDE client 810 that is communicatively coupled to the IDE 804 via one or more communication networks, such as network 806. In some examples, the network 806 is a LAN. In some examples, the network 806 is a WAN such as the Internet or the like.

A user uses the IDE client 810 to communicate with the IDE 804 and write the coding logic that is compiled by the compilers. During compilation, the compilers may access the cache 816 during compilation to store intermediate representations and/or executable objects of the coding logic. In some examples, the IDE client 810 is in communication with a client cache 812. The compilers may access the client cache 812 via the IDE client 810 during compilation to store intermediate representations and/or executable objects of the coding logic.

The compilation system 800 provides server-side compiling functionality as described herein via the Network 806 to the IDE client 810. While certain functions of the compilation system 800 are described herein as being performed by a compiler, such as compiler 1 824 and compiler N 820, the IDE 804, or one or more client-side API or applications, the location of certain functionality within the compilation system 800 or the client computing system 808 may be a design choice. For example, it may be technically preferable to initially deploy particular technology and functionality within the client computing system 808 but to later migrate this technology and functionality to the compilation system 800 where a computing system of the compilation system 800, such as computing system N 802, has sufficient processing capacity.

The compilation system 800 supports various services and operations that are provided to the client computing system 808. Such operations include transmitting data to, receiving data from, and processing data generated by the compilation system 800 and the client computing system 808. This data may include, but is not limited to, coding logic, intermediate representations and/or executable objects of coding logic, compilation metrics, execution metrics of one or more executable objects, and the like. The IDE 804 provides, via the IDE client 810, one or more User Interfaces (UI) that a user uses to access the functionality of the compilation system 800.

In some examples, the IDE 804, the cache 816, and one or more compilers, such as compiler 1 824 and compiler N 820, are hosted by a single computing system. In some examples, the IDE 804, the cache 816, and one or more compilers, such as compiler 1 824 and compiler N 820, are hosted in a cloud-based computing environment.

FIG. 9 is a diagrammatic representation of a machine 900 within which instructions 910 (e.g., software, a program, an application, an applet, an app, or other executable code) for causing the machine 900 to perform any one or more of the methodologies discussed herein may be executed. For example, the instructions 910 may cause the machine 900 to execute any one or more of the methods or processes described herein. The instructions 910 transform the general, non-programmed machine 900 into a particular machine 900 programmed to carry out the described and illustrated generators in the manner described. The machine 900 may operate as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 in conjunction with other components of a compiler system may generator as, but not limited to, a server, a client, computer, a personal computer (PC), a tablet computer, a laptop computer, or any machine capable of executing the instructions 910, sequentially or otherwise, that specify actions to be taken by the machine 900. Further, while a single machine 900 is illustrated, the term “machine” may also be taken to include a collection of machines that individually or jointly execute the instructions 910 to perform any one or more of the methodologies discussed herein.

The machine 900 may include one or more processors 902, memory 904, and I/O device interfaces 906, which may be configured to communicate with one another via a bus 932. In an example, the processors 902 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 908 and a processor 912 that execute the instructions 910. The term “processor” is intended to include multi-core processors that may comprise two or more independent processors (sometimes referred to as “cores”) that may execute instructions contemporaneously. Although FIG. 9 shows multiple processors 902, the machine 900 may include a single processor with a single core, a single processor with multiple cores (e.g., a multi-core processor), multiple processors with a single core, multiple processors with multiples cores, or any combination thereof.

The memory 904 includes a main memory 914, a static memory 916, and a storage unit 918, both accessible to the processors 902 via the bus 932. The main memory 904, the static memory 916, and storage unit 918 store the instructions 910 embodying any one or more of the methodologies or generators described herein. The instructions 910 may also reside, completely or partially, within the main memory 914, within the static memory 916, within a non-transitory machine-readable medium 920 within the storage unit 918, within one or more of the processors 902 (e.g., within the processor's cache memory), or any suitable combination thereof, during execution thereof by the machine 900.

The I/O device interfaces 906 couple the machine 900 to I/O devices 934. One or more of the I/O devices 934 may be a component of machine 900 or may be separate devices. The I/O device interfaces 906 may include a wide variety of interfaces to the I/O devices 934 used by the machine 900 to receive input, provide output, produce output, transmit information, exchange information, capture measurements, and so on. The specific I/O device interfaces 906 that are included in a particular machine will depend on the type of machine. It will be appreciated that the I/O device interfaces 906 the I/O devices 934 may include many other components that are not shown in FIG. 9. In various examples, the I/O device interfaces 906 may include output component interfaces 924 and input component interfaces 928. The output component interfaces 924 may include interfaces to visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input component interfaces 928 may include interfaces to alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O device interfaces 906 further include communication component interfaces 930 operable to couple the machine 900 to a network 922 or one or more devices 936 via coupling 926 and a coupling 938, respectively. For example, the communication component interfaces 930 may include an interface to a network interface component or another suitable device to interface with the network 922. In further examples, the communication component interfaces 930 may include interfaces to wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 936 may be another machine or any of a wide variety of peripheral devices (e.g., a peripheral device coupled via a USB).

The various memories (e.g., memory 904, main memory 914, static memory 916, and/or memory of the processors 902) and/or storage unit 918 may store one or more sets of instructions and data structures (e.g., software) embodying or used by any one or more of the methodologies or generators described herein. These instructions (e.g., the instructions 910), when executed by processors 902, cause various operations to implement the disclosed examples.

The instructions 910 may be transmitted or received over the network 922, using a transmission medium, via a network interface device (e.g., a network interface component included in the communication component interfaces 930) and using any one of a number of well-known transfer protocols (e.g., hypertext transfer protocol (HTTP)). Similarly, the instructions 910 may be transmitted or received using a transmission medium via the coupling 938 (e.g., a peer-to-peer coupling) to the devices 936.

### Further Examples Include

Example 1 is a computer-implemented method comprising: receiving, by one or more processors, a kernel definition comprising a parameterization and code of a set of generators written in a general purpose programming language; for each generator of the set of generators, performing operations comprising: translating, by the one or more processors, code of the each generator into a first intermediate representation of the each generator; determining, by the one or more processors, a configuration of the each generator using the parameterization and the first intermediate representation; generating, by the one or more processors, a second intermediate representation using the configuration; caching, by the one or more processors, the intermediate representation; and generating, by the one or more processors, a respective binary object of a set of binary objects using the second intermediate representation; and composing, by the one or more processors, a kernel corresponding to the kernel definition using the set of binary objects.

In Example 2, the subject matter of Example 1 wherein caching the intermediate representation comprises: detecting an operation in the second intermediate representation; detecting a region in a body of the operation; generating a parameterized Content Addressable Store IDentifier (CAS ID) using a content of the region; copying the region into a container; and caching the container in a hash table using the parameterized CAS ID.

In Example 3, the subject matter of Example 2 wherein determining the configuration of the each generator comprises: determining a region in the first intermediate representation; generating a parameterized CAS ID using the intermediate representation; and searching the hash table for a cached intermediate representation corresponding to the region using the parameterized CAS ID.

In Example 4, the subject matter of Examples 2-3 wherein determining the configuration of the each generator is performed on a plurality of machines.

In Example 5, the subject matter of Examples 1-4 wherein determining the configuration of the each generator comprises: generating a set of configurations of the each generator using the parameterization and the intermediate representation of the each generator; generating an executable set of test functions using the set of configurations; executing the set of test functions to determine a set of respective performance scores; selecting an optimal configuration of the set of configurations using the set of respective performance scores; and determining the configuration of the each generator using the optimal configuration.

In Example 6, the subject matter of Example 5 wherein generating the set of configurations is further using a target machine parameterization.

In Example 7, the subject matter of Examples 5-6 wherein the set of test functions are executed on a plurality of machines.

Example 8 is a machine comprising: one or more processors; and memory storing instructions that, when executed by the one or more processors, cause the machine to perform operations comprising: receiving a kernel definition comprising a parameterization and code of a set of generators written in a general purpose programming language; for each generator of the set of generators, performing operations comprising: translating code of the each generator into a first intermediate representation of the each generator; determining a configuration of the each generator using the parameterization and the first intermediate representation; generating a second intermediate representation using the configuration; caching the intermediate representation; and generating a respective binary object of a set of binary objects using the second intermediate representation; and composing a kernel corresponding to the kernel definition using the set of binary objects.

In Example 9, the subject matter of Example 8 wherein caching the intermediate representation comprises: detecting an operation in the second intermediate representation; detecting a region in a body of the operation; generating a parameterized Content Addressable Store IDentifier (CAS ID) using a content of the region; copying the region into a container; and caching the container in a hash table using the parameterized CAS ID.

In Example 10, the subject matter of Example 9 wherein determining the configuration of the each generator comprises: determining a region in the first intermediate representation; generating a parameterized CAS ID using the intermediate representation; and searching the hash table for a cached intermediate representation corresponding to the region using the parameterized CAS ID.

In Example 11, the subject matter of Examples 9-10 wherein determining the configuration of the each generator is performed on a plurality of machines.

In Example 12, the subject matter of Examples 8-11 wherein determining the configuration of the each generator comprises: generating a set of configurations of the each generator using the parameterization and the intermediate representation of the each generator; generating an executable set of test functions using the set of configurations; executing the set of test functions to determine a set of respective performance scores; selecting an optimal configuration of the set of configurations using the set of respective performance scores; and determining the configuration of the each generator using the optimal configuration.

In Example 13, the subject matter of Example 12 includes, wherein generating the set of configurations is further using a target machine parameterization.

In Example 14, the subject matter of Examples 12-13 wherein the set of test functions are executed on a plurality of machines.

Example 15 is a machine-storage medium, the machine-readable storage medium including instructions that, when executed by one or more processors of a machine, cause the machine to perform operations comprising: receiving a kernel definition comprising a parameterization and code of a set of generators written in a general purpose programming language; for each generator of the set of generators, performing operations comprising: translating code of the each generator into a first intermediate representation of the each generator; determining a configuration of the each generator using the parameterization and the first intermediate representation; generating a second intermediate representation using the configuration; cache the intermediate representation; and generating a respective binary object of a set of binary objects using the second intermediate representation; and compose a kernel corresponding to the kernel definition using the set of binary objects.

In Example 16, the subject matter of Example 15 wherein caching the intermediate representation comprises: detecting an operation in the second intermediate representation; detecting a region in a body of the operation; generating a parameterized Content Addressable Store IDentifier (CAS ID) using a content of the region; copying the region into a container; and caching the container in a hash table using the parameterized CAS ID.

In Example 17, the subject matter of Example 16 wherein determining the configuration of the each generator comprises: determining a region in the first intermediate representation; generating a parameterized CAS ID using the intermediate representation; and searching the hash table for a cached intermediate representation corresponding to the region using the parameterized CAS ID.

In Example 18, the subject matter of Examples 16-17 wherein determining the configuration of the each generator is performed on a plurality of machines.

In Example 19, the subject matter of Examples 15-18 wherein determining the configuration of the each generator comprises: generating a set of configurations of the each generator using the parameterization and the intermediate representation of the each generator; generating an executable set of test functions using the set of configurations; executing the set of test functions to determine a set of respective performance scores; selecting an optimal configuration of the set of configurations using the set of respective performance scores; and determining the configuration of the each generator using the optimal configuration.

In Example 20, the subject matter of Example 19 wherein generating the set of configurations is further using a target machine parameterization.

In Example 21, the subject matter of Examples 19-20 wherein the set of test functions are executed on a plurality of machines.

Example 22 is at least one machine-readable medium including instructions that, when executed by processing circuitry, cause the processing circuitry to perform operations to implement any of Examples 1-21.

Example 23 is an apparatus comprising means to implement any of Examples 1-21.

Example 24 is a system to implement any of Examples 1-21.

Example 25 is a method to implement any of Examples 1-21.

Changes and modifications may be made to the disclosed examples without departing from the scope of the present disclosure. These and other changes or modifications are intended to be included within the scope of the present disclosure, as expressed in the following claims.

### Glossary

A “carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

A “client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

A “communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

A “machine-readable medium” refers to both machine-storage media and transmission media. Thus, the terms include both storage devices/media and carrier waves/modulated data signals. The terms “machine-readable medium,” “machine-readable medium” and “device-readable medium” mean the same thing and may be used interchangeably in this disclosure.

A “machine-storage medium” refers to a single or multiple storage devices and/or media (e.g., a centralized or distributed database, and/or associated caches and servers) that store executable instructions, routines and/or data. The term includes, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at some of which are covered under the term “signal medium.”

A “processor” refers to any circuit or virtual circuit (a physical circuit emulated by logic executing on an actual processor) that manipulates data values according to control signals (e.g., “commands”, “op codes”, “machine code”, and so forth) and which produces associated output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

A “signal medium” refers to any intangible medium that is capable of storing, encoding, or carrying the instructions for execution by a machine and includes digital or analog communications signals or other intangible media to facilitate communication of software or data. The term “signal medium” may be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

A “kernel” or “microkernel” are implementations of an algorithm that does computation against memory objects like memory buffers of a certain layout. The two terms may be used interchangeably, but “microkernel” tends to connote a small operation (e.g., memset, dot product or reduction) within a larger generator kernel implementation. Algorithmically interchangeable/equivalent/replaceable kernels are sometimes referred to as “codelets” in literature.

A “generator” is a meta program that is parameterized and is executed to generate a non-parametric implementation of a kernel or microkernel. Fixed kernel implementations (e.g., a panel dot product implemented in assembly) are a degenerate case of a generator with no parameters.

A “kernel interface declaration” is a declaration of kernel or microkernel that applies to multiple implementations of a kernel or microkernel. Kernels and microkernels may be implemented multiple times in multiple different ways. An interface declaration can stand alone from the implementations, allowing clients and implementations to be type checked.

A “generator parameter argument” refers to a value that a kernel or a microkernel is allowed to act on. A generator is a meta program that generates a kernel, and “parameters” are the values that this meta program is allowed to act on.

A “kernel generator parameter result” is a value returned by a generator to its invoker as parameters, allowing them to adapt to behavior in the generated sub-kernel. For example, a panel dot product generator could return “I processed a 3×5 panel of memory”, which causes the invoking for loop to step by 3 and 5 on each dimension.

A “generator constraint” is a constraint indicating limitations on parameters of a kernel or microkernel, e.g., “this implementation only works with dtype=float32”, or “this only works on machines with X86 VNNI extension”, this “works for sizes modulo 136” and the like. Generators are allowed to be partial generators from the interface declaration to a concrete implementation. Constraints are upward propagated from kernel implementations out to the generator graph.

A “kernel argument” is a Static Single Assignment (SSA) argument value used for: buffers and other user defined types for structured abstractions over memory, like linear memory, N-dimensional tensors with layouts, and other higher level data types like trees and tables; the values corresponding to op attributes in the tensor graph level, while they may be modeled as constants there, they are dynamic values for the runtime implementation of the kernel; and very small micro kernels at the bottom of the stack (e.g., add two integers) use arguments for their inputs.

A “kernel result” is a SSA result value used for: dynamically allocated result buffers, e.g., those that have data dependent shapes; and very small micro kernels at the bottom of the stack (e.g., add two integers) use results for their outputs.

1. A computer-implemented method comprising:
receiving, by one or more processors, a kernel definition comprising a parameterization and code of a set of generators written in a general purpose programming language;
for each generator of the set of generators, performing operations comprising:
translating, by the one or more processors, code of the each generator into a first intermediate representation of the each generator;
determining, by the one or more processors, a configuration of the each generator using the parameterization and the first intermediate representation;
generating, by the one or more processors, a second intermediate representation using the configuration;
caching, by the one or more processors, the intermediate representation; and
generating, by the one or more processors, a respective binary object of a set of binary objects using the second intermediate representation; and
composing, by the one or more processors, a kernel corresponding to the kernel definition using the set of binary objects.

2. The computer-implemented method of claim 1, wherein caching the intermediate representation comprises:
detecting an operation in the second intermediate representation;
detecting a region in a body of the operation;
generating a parameterized Content Addressable Store IDentifier (CAS ID) using a content of the region;
copying the region into a container; and
caching the container in a hash table using the parameterized CAS ID.

3. The computer-implemented method of claim 2, wherein determining the configuration of the each generator comprises:
determining a region in the first intermediate representation;
generating a parameterized CAS ID using the intermediate representation; and
searching the hash table for a cached intermediate representation corresponding to the region using the parameterized CAS ID.

4. The computer-implemented method of claim 2, wherein determining the configuration of the each generator is performed on a plurality of machines.

5. The computer-implemented method of claim 1, wherein determining the configuration of the each generator comprises:
generating a set of configurations of the each generator using the parameterization and the intermediate representation of the each generator;
generating an executable set of test functions using the set of configurations;
executing the set of test functions to determine a set of respective performance scores;
selecting an optimal configuration of the set of configurations using the set of respective performance scores; and
determining the configuration of the each generator using the optimal configuration.

6. The computer-implemented method of claim 5, wherein generating the set of configurations is further using a target machine parameterization.

7. The computer-implemented method of claim 5, wherein the set of test functions are executed on a plurality of machines.

8. A machine comprising:
one or more processors; and
one or more memories storing instructions that, when executed by the one or more processors, cause the machine to perform operations comprising:
receiving a kernel definition comprising a parameterization and code of a set of generators written in a general purpose programming language;
for each generator of the set of generators, performing operations comprising:
translating code of the each generator into a first intermediate representation of the each generator;
determining a configuration of the each generator using the parameterization and the first intermediate representation;
generating a second intermediate representation using the configuration;
caching the intermediate representation; and
generating a respective binary object of a set of binary objects using the second intermediate representation; and
composing a kernel corresponding to the kernel definition using the set of binary objects.

9. The machine of claim 8, wherein caching the intermediate representation comprises:
detecting an operation in the second intermediate representation;
detecting a region in a body of the operation;
generating a parameterized Content Addressable Store IDentifier (CAS ID) using a content of the region;
copying the region into a container; and
caching the container in a hash table using the parameterized CAS ID.

10. The machine of claim 9, wherein determining the configuration of the each generator comprises:
determining a region in the first intermediate representation;
generating a parameterized CAS ID using the intermediate representation; and
searching the hash table for a cached intermediate representation corresponding to the region using the parameterized CAS ID.

11. The machine of claim 9, wherein determining the configuration of the each generator is performed on a plurality of machines.

12. The machine of claim 8, wherein determining the configuration of the each generator comprises:
generating a set of configurations of the each generator using the parameterization and the intermediate representation of the each generator;
generating an executable set of test functions using the set of configurations;
executing the set of test functions to determine a set of respective performance scores;
selecting an optimal configuration of the set of configurations using the set of respective performance scores; and
determining the configuration of the each generator using the optimal configuration.

13. The machine of claim 12, wherein generating the set of configurations is further using a target machine parameterization.

14. The machine of claim 12, wherein the set of test functions are executed on a plurality of machines.

15. A machine-storage medium including instructions that, when executed by one or more processors of a machine, cause the machine to perform operations comprising:
receiving a kernel definition comprising a parameterization and code of a set of generators written in a general purpose programming language;
for each generator of the set of generators, performing operations comprising:
translating code of the each generator into a first intermediate representation of the each generator;
determining a configuration of the each generator using the parameterization and the first intermediate representation;
generating a second intermediate representation using the configuration;
cache the intermediate representation; and
generating a respective binary object of a set of binary objects using the second intermediate representation; and
compose a kernel corresponding to the kernel definition using the set of binary objects.

16. The machine-storage medium of claim 15, wherein caching the intermediate representation comprises:
detecting an operation in the second intermediate representation;
detecting a region in a body of the operation;
generating a parameterized Content Addressable Store IDentifier (CAS ID) using a content of the region;
copying the region into a container; and
caching the container in a hash table using the parameterized CAS ID.

17. The machine-storage medium of claim 16, wherein determining the configuration of the each generator comprises:
determining a region in the first intermediate representation;
generating a parameterized CAS ID using the intermediate representation; and
searching the hash table for a cached intermediate representation corresponding to the region using the parameterized CAS ID.

18. The machine-storage medium of claim 16, wherein determining the configuration of the each generator is performed on a plurality of machines.

19. The machine-storage medium of claim 15, wherein determining the configuration of the each generator comprises:
generating a set of configurations of the each generator using the parameterization and the intermediate representation of the each generator;
generating an executable set of test functions using the set of configurations;
executing the set of test functions to determine a set of respective performance scores;
selecting an optimal configuration of the set of configurations using the set of respective performance scores; and
determining the configuration of the each generator using the optimal configuration.

20. The machine-storage medium of claim 19, wherein generating the set of configurations is further using a target machine parameterization.
